(19) United States
(12) Patent Application Publication
(10) Pub. No.: US 2015/0118332 A1
(43) Pub. Date: Apr. 30, 2015

(54) NON-TOXIC ECTOPARASITE TREATMENT COMPOSITION AND METHOD OF USE

(71) Applicant: Colleen Novelo, Shingle Springs, CA (US)

(72) Inventor: Colleen Novelo, Shingle Springs, CA (US)

(21) Appl. No.: 14/522,318

(22) Filed: Oct. 23, 2014

Related U.S. Application Data
(60) Provisional application No. 61/895,973, filed on Oct. 25, 2013.

(51) Int. Cl. A01N 65/24; A01N 65/28; A01N 65/36; A01N 65/22; A01N 65/44

(52) U.S. Cl. CPC A01N 65/24; A01N 65/22; A01N 65/44; A01N 65/36; A01N 65/28
USPC 424/736; 424/739

(57) ABSTRACT

A non-toxic composition for the treatment and prevention of ectoparasite infestations is provided. In its most basic form, the composition comprises a combination of effective amounts of cinnamon oil, oregano oil and either citronella oil or lavender oil. Additional oils, including both citronella oil and lavender oil, in addition to peppermint oil, orange oil, tea tree oil and rosemary oil may be added to the composition while still maintaining the efficacy of the composition. The composition may be combined with a carrier agent and the combination may be applied to a subject to effect the elimination of ectoparasites and the prevention of new infestations. Preferably, the carrier agent is a shampoo, a conditioner, a non-aqueous spray, a body wash or a lotion.

### CROSS-REFERENCE TO RELATED APPLICATIONS

This application claims priority to U.S. Provisional Patent Application No. 61/895,973 entitled “Herbal Pest Treatment Compound and Method”, filed on Oct. 25, 2013, the contents of which are incorporated herein by reference.

### FIELD OF THE INVENTION

This invention relates to compositions and methods for the treatment and prevention of ectoparasite infestations including lice, ticks, fleas, mites and bed bugs on host subjects. The inventive compositions and methods are applicable to humans, animals and inanimate objects. The inventive compositions for the treatment and prevention of ectoparasites are non-toxic and contain only natural ingredients.

### BACKGROUND OF THE INVENTION

Infestation of lice, ticks, mites, fleas and other ectoparasites is a common problem in humans and animals. The infestations are commonly spread between subjects as a result of the subjects being in close contact, such as in a school environment for humans or in a kennel for animals. Infestations may also be easily spread by the sharing of articles of clothing and grooming implements.

Various techniques are known in the art for the treatment and prevention of ectoparasite infestations of humans, animals and inanimate objects. Historically, compositions including toxic pesticides have been developed to treat ectoparasite infestations. However, these toxic compositions are known to be harmful to the subject being treated and to the environment. Additionally, it has been shown that ectoparasites become resistant to many of these toxic pesticides.

In addition, while ectoparasite treatments are known in the art utilizing natural ingredients, it has been demonstrated that in order for these individual natural ingredients to be effective in eliminating or reducing the ectoparasites, they must be administered at high concentrations levels. The required high concentration levels of the effective ingredient in the prior art treatments commonly result in undesirable side effects, including skin irritation and burning sensations at the treatment site. While reducing the effective ingredient in the prior art treatments may prevent some of these unwanted side effects, it has been shown that the reduction in the effective ingredient also reduces the overall effectiveness of the treatment.

Accordingly, there is a need for an affordable, non-toxic, composition containing natural ingredients that is effective in the treatment of ectoparasites including lice, fleas, ticks and mites.

### SUMMARY OF INVENTION

A non-toxic composition for the treatment and prevention of ectoparasite infestations is provided. In its most basic form, the composition comprises a combination of effective amounts of cinnamon oil, oregano oil and either citronella oil or lavender oil. Additional oils, including both citronella oil and lavender oil, in addition to peppermint oil, orange oil, tea tree oil and rosemary oil may be added to the composition while still maintaining the efficacy of the composition. The composition may be combined with a carrier agent and the combination may be applied to a subject to effect the elimination of ectoparasites and the prevention of new infestations. Preferably, the carrier agent is a shampoo, a conditioner, a non-aqueous spray, a body wash or a lotion.

In one embodiment, the composition of the present invention comprises about 5% to about 20% cinnamon oil, about 10% to about 15% oregano oil and about 5% to about 10% citronella oil. More specifically, the composition comprises about 8% cinnamon oil, about 14% oregano oil and about 5% citronella oil.

In an additional embodiment, the composition includes about 5% to about 20% cinnamon oil, about 10% to about 15% oregano oil, about 10% to about 40% lavender oil, about 10% to about 15% peppermint oil, about 5% to about 10% citronella oil, about 7% to about 10% orange oil, about 5% to about 15% tea tree oil and about 5% to about 10% rosemary oil. More specifically, the composition may include about 8% cinnamon oil, about 14% oregano oil, about 40% lavender oil, about 10% peppermint oil, about 5% citronella oil, about 7% orange oil, about 6% tea tree oil and about 6% rosemary oil.

A method for the treatment and prevention of ectoparasite infestations of a subject in accordance with the present invention may include, topically applying to the subject an amount of the composition of the present invention in an amount sufficient to treat or prevent the ectoparasite infestation of the subject. Alternative, the composition of the present invention may be combined with an appropriate carrier agent prior to topically applying to the subject. The subject may be a human, an animal or an inanimate object.

The present invention provides an affordable, non-toxic, composition containing natural ingredients that is effective in the treatment of ectoparasites including lice, fleas, ticks and mites. The composition of natural ingredients in the ectoparasite treatment of the present invention reduces unwanted side effects while still maintaining the effectiveness of the composition in eliminating the ectoparasites.

### DETAILED DESCRIPTION OF THE INVENTION

The present invention will now be described in detail with reference to several embodiments thereof as illustrated in the accompanying drawings. In the following description, numerous specific details are set forth in order to provide a thorough understanding of embodiments of the present invention. It will be apparent, however, to one skilled in the art, that embodiments may be practiced without some or all of these specific details. In other instances, well known process steps and/or structures have not been described in detail in order to not unnecessarily obscure the present invention. The features and advantages of embodiments may be better understood with reference to the drawings and discussions that follow.

As described herein, the invention is a composition, and a method of use thereof, for eliminating and deterring infestations of ectoparasites on humans, pets and inanimate objects. The composition is a topical treatment that is non-toxic and is composed of all natural essential oils. It is to be understood that the composition of the present invention may include other inactive ingredients that do not interfere with the effectiveness of the composition in eliminating and deterring infestations of ectoparasites.

An “ectoparasite” as used herein, is meant to include all parasites, such as lice, fleas, ticks, mites, chiggers, for example, that rely on a host for survival. The composition of the present invention is non-toxic to the host, but toxic to the ectoparasites. The composition of the present invention is, therefore, intended to be used against all such parasites which can be removed from the host by the use of the present invention.

The composition of the present invention may be provided to a user in a concentrated form. Alternatively, the composition may first be diluted in a carrier agent, such as a shampoo, conditioner, spray, lotion, for example, and then provided to a user in its diluted form. The composition in combination with the carrier agent has been shown to reduce possible negative characteristics of the composition, including causing minor skin irritation and objectionable aroma of the composition.

In one embodiment, the non-toxic composition of the present invention includes an effective amount of cinnamon oil, oregano oil and either citronella oil or lavender oil. The cinnamon oil and oregano oil are effective in killing the ectoparasites. The citronella oil and lavender oil provide an additional deterring effect, thereby preventing a new infestation of the ectoparasites.

In one embodiment, the composition may include about 5% to about 20% cinnamon oil, about 10% to about 15% oregano oil and about 5% to about 10% citronella oil. More specifically, the composition may include about 8% cinnamon oil, about 14% oregano oil and about 5% citronella oil.

In an additional embodiment, the composition may include about 5% to about 20% cinnamon oil, about 10% to about 15% oregano oil and 10% to about 40% lavender oil. More specifically, the composition includes about 8% cinnamon oil, about 14% oregano oil and about 40% lavender oil.

Additional oils may be added to the composition, each of these additional oils providing one or more desirable effects, such as providing soothing or healing effects to the user of the composition. In a particular embodiment, the composition includes about 5% to about 20% cinnamon oil, about 10% to about 15% oregano oil, about 10% to about 40% lavender oil, about 10% to about 15% peppermint oil, about 5% to about 10% citronella oil, about 7% to about 10% orange oil, about 5% to about 15% tea tree oil and about 5% to about 10% rosemary oil. More specifically, the composition may include about 8% cinnamon oil, about 14% oregano oil, about 40% lavender oil, about 10% peppermint oil, about 5% citronella oil, about 7% orange oil, about 6% tea tree oil and about 6% rosemary oil.

The percentages provided in these embodiments are applicable to both volume percentages and weight percentages. Additionally, to provide a desired volume of the composition, any of a variety of inactive ingredients may be added to the composition. In particular, inactive ingredients combine effectively with the various oils of the composition are preferred.

The various combinations of elements in the compositions of the present invention may be provided to a user in a concentrated form. While the compositions are non-toxic to the user, they may produce some undesirable effects, such as minor skin irritations. To reduce these undesirable effects, the compositions of the present invention may be combined with a carrier agent. Acceptable carrier agents may include, shampoo, conditioner, leave-in spray, body wash, fogger, lotions, for example. This listing of acceptable carrier agents is not intended to be limiting and any of a variety of other acceptable carrier agents are within the scope of the present invention. A carrier agent is considered acceptable if it can effectively distribute the composition to the ectoparasite infestation, while still maintaining the effectives of the composition in eliminating and/or deterring the ectoparasites.

In a particular embodiment, the non-toxic composition of the present invention is combined with a carrier agent at a ratio of about 1% of the composition to about 99% of the carrier agent. In an exemplary embodiment, a 1/8 oz. (1 fluid dram) of the composition of the present invention is combined with 16 oz. of the carrier agent. In an additional exemplary embodiment, a ⅛ oz. (1 fluid dram) of the composition of the present invention is combined with 32 oz. of the carrier agent.

The compositions of the present invention are effective for the elimination and deterrence of ectoparasites when applied to human subjects and animals. In addition, the efficacy of the compositions demonstrated on a living human or animal is less predictable than the efficacy demonstrated on an inanimate object. As such, it follows that the compositions are also effective in eliminating and deterring ectoparasites on inanimate objects, such as clothing, furniture, bedding, for example. In addition, it is apparent that the compositions would also be effective in the treatment of an entire physical area, such as in the form of a room fogger or a non-aerosol spray.

The following exemplary treatments are presented as possible effective uses of the compositions of the present invention for the elimination and deterrence of ectoparasites. Any of the exemplary compositions, comprising various percentages of ingredients, as previously described may be considered for use in the treatments described below.

### Human Head Lice Treatment

For the treatment of human head lice, the compositions of the present invention may be added to a carrier agent, such as a shampoo, conditioner or leave-in conditioner. In a particular embodiment, ⅛ oz. of the composition is combined with 16 oz. or 20 oz. of the carrier agent. In use, the shampoo and/or conditioner containing the composition of the present invention is applied to the human hair and allowed to remain in the hair for a predetermined active period. The active period may vary dependent upon the specific composition of the invention. In one embodiment, the active period may be five minutes. Following the active period, the composition and carrier agent are rinsed from the hair and any dead parasites or eggs may be removed using a comb. These treatment steps may be repeated as necessary to eliminate the lice infestation and deter the possibility of a new infestation. Additionally, a leave-in hair conditioner including an effective amount of the composition of the present invention may be applied to the hair to deter a new infestation of lice.

In an exemplary embodiment, human subjects ranging from infancy to elderly adults suffering from a head lice infestation were treated with 1/8 oz. of the composition combined with a 16 oz. shampoo, ⅛ oz. of the composition combined with a 16 oz. conditioner. The subjects used the shampoo and the conditioner on a daily basis until the infestation was eliminated.

In an additional exemplary embodiment, human subjects ranging from infancy to elderly adults suffering from a head lice infestation were treated with ⅛ oz. of the composition combined with 8oz. or 16 oz. of a leave-in spray conditioner. The spray was applied daily to the hair of the subject and the infestation was eliminated within 5 days of the beginning of the treatment. Additionally, the subjects continued to use the leave-in spray conditioner after the removal of the infestation as a preventative measure, resulting in no new infestations.

### Human Body Lice, Chiggers and Mites Treatment

For the treatment of human body lice and/or mites, the compositions of the present invention may be added to a carrier agent, such as a body wash, lotion or an oil based carrier. In a particular embodiment, ⅛ oz. of the composition is combined with 20 oz. or 25 oz. of the carrier agent. In use, the body wash containing the composition is applied to the skin for an amount of time effective to eliminate the infestation. In a particular embodiment, the body wash is applied to the skin for two weeks. These treatment steps may be repeated as necessary to eliminate the infestation and deter the possibility of a new infestation.

In an exemplary embodiment, a human subject suffering from a body lice infestation was treated with ⅛ oz. of the composition combined with a body wash. The subject utilized the body wash daily and the infestation was eliminated within 2 days of the initiation of the treatment.

### Animal Lice, Mites, Fleas, Ticks and Chiggers Treatment

For the treatment of animal lice, mites, fleas, ticks or chiggers, the compositions of the present invention may be added to a carrier agent, such as shampoo and leave-in spray. In a particular embodiment, ⅛ oz. of the composition is combined with 16 oz. of the carrier agent. In use, the shampoo containing the composition is applied to the hair/fur of the animal and allowed to remain in the hair for a predetermined active period. In one embodiment, the active period may be five minutes. Following the active period, the composition and carrier agent are rinsed from the hair/fur. These treatment steps may be repeated as necessary to eliminate the infestation and deter the possibility of a new infestation. Additionally, a leave-in spray including an effective amount of the composition of the present invention may be applied to the animal hair/fur to deter a new infestation.

In an exemplary embodiment, an 8 month old goat infested with animal lice was treated with ⅛ oz. of the composition combined with a 16 oz. shampoo and ⅛ oz. of the composition combined with 16 oz. of leave-in spray. The treatment was effective in eliminating the lice and rash caused by the infestation within 12 hours of the first treatment.

### Chicken Lice And Mites Treatment

For the treatment of chicken lice and/or mites, the compositions of the present invention may be added to a carrier agent, such as spray that can be used on both the chickens and the living area of the chickens. In a particular embodiment, ⅛ oz. of the composition is combined with 16 oz. of the carrier agent. In use, the spray including the composition is applied to the chickens and the chicken pens and allowed to remain there. These treatment steps may be repeated as necessary to eliminate the infestation and deter the possibility of a new infestation.

In an exemplary embodiment, chickens infested with mites and/or lice and the bedding was treated with ⅛ oz. of the composition diluted with 1 gallon of water. The diluted composition was applied to the chickens and the bedding daily and the bedding was changed daily. After approximately 2 weeks the infestation had been eliminated.

### Cat Fleas, Mites, Ticks and Chiggers Treatment

For the treatment of cat fleas, mites ticks or chiggers, the compositions of the present invention may be added to a carrier agent, such as spray that can be used on the cats. In a particular embodiment, ⅛ oz. of the composition is combined with 16 oz. of the carrier agent. In use, the spray including the composition is applied to the cats allowed to remain there. These treatment steps may be repeated as necessary to eliminate the infestation and deter the possibility of a new infestation.

In an exemplary embodiment, cats infested with fleas were treated with ⅛ oz. of the composition combined with 16 oz. of a shampoo and ⅛ oz. of the composition combined with 16 oz. of a leave-in spray. The cats were shampooed, towel dried and sprayed with the leave-in spray. The spray was reapplied for the following 6 days and then the cats were shampooed again. Application of the spray was continued until the fleas were eliminated. The spray was continued as a preventative measure.

### Dog Fleas, Mites, Ticks and Chiggers Treatment

For the treatment of dog fleas, mites, ticks or chiggers, the compositions of the present invention may be added to a carrier agent, such as shampoo and leave-in spray. In a particular embodiment, ⅛ oz. of the composition is combined with 16 oz. of the carrier agent. In use, the shampoo containing the composition is applied to the hair/fur of the dog and allowed to remain in the hair/fur for a predetermined active period. In one embodiment, the active period may be five minutes. Following the active period, the composition and carrier agent are rinsed from the hair/fur. These treatment steps may be repeated as necessary to eliminate the infestation and deter the possibility of a new infestation. Additionally, a leave-in spray including an effective amount of the composition of the present invention may be applied to the dog hair/fur to deter a new infestation.

In an exemplary embodiment, a 2 year old German Shepherd residing at a kennel and professional training center was infested with fleas and was treated with ⅛ oz. of the composition combined with 16 oz. of shampoo and ⅛ oz. of the composition combined with 16 oz. of leave-in spray conditioner. The dog was treated with the compositions once a day for 10 days, which was successful in eliminating the infestation. The dog continues to be treated once a week with the compositions for preventative measures. In addition, ½ oz. of the composition was combined with 1 gallon of water and mixed with a carpet shampoo for treatment of infested carpeted areas resulting from the dog flea infestation and ⅛ oz. of the composition combined with 16 oz. of a spray for the treatment of other areas exposed to the fleas, such as the kennel and training buildings. Treatments of the carpet and surrounding areas have prevented the re-infestation of these areas.

### Bed Bug Treatment

For the treatment of bed bugs, the compositions of the present invention may be added to a carrier agent, such as shampoo for a carpet shampoo machine for treatment of carpets or upholstery. Alternatively, ⅛ oz. of the composition may be diluted in 1 gallon of water for the treatment of hard surfaces and to apply to bedding and clothing. The composition may take the form of a spray or a fogger. In use, the spray is applied to the infested articles and the treatment is repeated as necessary to eliminate the infestation and deter the possibility of a new infestation.

The various embodiments of the composition of the present invention and effective uses of the invention, as previously described, provide non-toxic, affordable solutions for eliminating ectoparasites and deterring new infestations on humans, animals and inanimate objects.

While this invention has been described in terms of several embodiments, there are alterations, modifications, permutations, and substitute equivalents, which fall within the scope of this invention. It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

What is claimed is:

1. A non-toxic composition for the treatment and prevention of ectoparasite infestations, the composition comprising an effective amount of cinnamon oil, oregano oil and an oil selected from the group consisting of citronella oil and lavender oil.

2. The composition of claim 1, comprising about 5% to about 20% cinnamon oil, about 10% to about 15% oregano oil and about 5% to about 10% citronella oil.

3. The composition of claim 1, comprising about 5% to about 20% cinnamon oil, about 10% to about 15% oregano oil and about 10% to about 40% lavender oil.

4. The composition of claim 1, comprising about 8% cinnamon oil, about 14% oregano oil and about 5% citronella oil.

5. The composition of claim 1, comprising about 8% cinnamon oil, about 14% oregano oil and about 40% lavender oil.

6. The composition of claim 1, wherein the composition is combined with a carrier agent.

7. The composition of claim 1, wherein the composition is combined with a carrier agent at a ratio of about 1% of the composition to about 99% of the carrier agent.

8. The composition of claim 7, wherein the carrier agent is selected from the group consisting of an oil based carrier agent, a shampoo, a conditioner, a non-aerosol spray, a lotion, a liquid body wash and a fogging solution.

9. The composition of claim 1, further comprising one or more ingredients selected from the group consisting of peppermint oil, orange oil, tea tree oil and rosemary oil.

10. The composition of claim 2, further comprising about 10% to about 40% lavender oil.

11. The composition of claim 3, further comprising about 5% to about 10% citronella oil.

12. The composition of claim 1, further comprising about 10% to about 15% peppermint oil.

13. The composition of claim 1, further comprising about 7% to about 10% orange oil.

14. The composition of claim 1, further comprising about 5% to about 15% tea tree oil.

15. The composition of claim 1, further comprising about 5% to about 10% rosemary oil.

16. A non-toxic composition for the treatment and prevention of ectoparasite infestations, the composition comprising:
about 5% to about 20% cinnamon oil;
about 10% to about 15% oregano oil;
about 10% to about 40% lavender oil;
about 10% to about 15% peppermint oil;
about 5% to about 10% citronella oil;
about 7% to about 10% orange oil;
about 5% to about 15% tea tree oil; and
about 5% to about 10% rosemary oil.

17. A non-toxic composition for the treatment and prevention of ectoparasite infestations, the composition comprising:
about 8% cinnamon oil;
about 14% oregano oil;
about 40% lavender oil;
about 10% peppermint oil;
about 5% citronella oil;
about 7% orange oil;
about 6% tea tree oil; and
about 6% rosemary oil.

18. The composition of claim 16, wherein the composition is combined with a carrier agent at a ratio of about 1% of the composition to about 99% of the carrier agent.

19. A method for the treatment and prevention of ectoparasite infestations of a subject, the method comprising topically applying to the subject an amount of the composition of claim 1 in an amount sufficient to treat or prevent the ectoparasite infestation of the subject.

20. The method of claim 18, further comprising combining the composition of claim 1 with a carrier agent prior to topically applying the composition to the subject.
